(19) United States
(12) Patent Application Publication
(10) Pub. No.: US 2026/0212283 A1
(43) Pub. Date: Jul. 23, 2026

(54) SYSTEMS AND METHODS FOR FOCUSING ATTENTION TO PRIORITY NARRATIVES

(71) Applicant: SocialTrendly, Inc. d/b/a Blackbird.AI, Rochester, NY (US)

(72) Inventors: Paul Burkard, Kure Beach, NC (US); Naushad UzZaman, Bellmore, NY (US); John Wissinger, Tucson, AZ (US); Wasim Khaled, Pittsford, NY (US)

(73) Assignee: SocialTrendly, Inc. d/b/a Blackbird.AI, Rochester, NY (US)

(21) Appl. No.: 19/457,658

(22) Filed: Jan. 23, 2026

Related U.S. Application Data
(60) Provisional application No. 63/748,751, filed on Jan. 23, 2025.

(51) Int. Cl. G06N 20/20; G06F 16/353; G06F 16/383; G06F 16/901

(52) U.S. Cl. CPC G06N 20/20; G06F 16/353; G06F 16/383; G06F 16/9024

(57) ABSTRACT

Disclosed embodiments may provide techniques for focusing attention to priority narratives. A computer-implemented method can include receiving input data identifying one or more characteristics associated with a target domain. The computer-implemented method can also include processing a corpus of unstructured data using the input data to generate a set of priority narratives associated with the target domain. The computer-implemented method can include determining, for each of the set of priority narratives, one or more propagation paths of the priority narrative across a digital communication network.

### CROSS-REFERENCES TO RELATED APPLICATIONS

The present application claims priority from and is a non-provisional of U.S. Provisional Application No. 63/748,751, entitled “A SYSTEM AND METHOD FOR FOCUSING ATTENTION TO THE HIGHEST VALUE NARRATIVE OPPORTUNITIES AND RISKS” filed Jan. 23, 2025, the contents of which are herein incorporated by reference in its entirety for all purposes.

### FIELD

The present disclosure relates generally to automatically surfacing priority narratives. In one example, the systems and methods described herein may be used to implement an ensemble of machine-learning models that process a corpus of unstructured data to automatically identify the priority narratives corresponding to a user-defined target domain.

### BACKGROUND

Understanding the public narrative around an organization can help it proactively mitigate reputational harm. Surfacing the conversations and perceptions of most concern, early enough in their evolution to respond, is a critical value proposition. In the case of security related concerns, early warning allows security teams to proactively adapt their posture, for example responding to a call to action for a protest event with additional security personnel. Understanding the actors involved, e.g., membership in an activist organization, can help in attributing their perspectives within the narrative, and where they may take it next.

Online misinformation and disinformation in particular create numerous harms, from reputational harms, to financial harms such as stock price manipulation, to personal injuries as in the case of fraudulent medical advice. Assisting users in understanding when narratives contain disinformation, and where it appears to be coming from, can assist them in weighing information properly. Also, in order to combat disinformation campaigns, it is critical to understand what audiences have been exposed to the disinformation narrative, and the cohort affiliations of those audiences to craft the most effective countermeasures.

### SUMMARY

Disclosed embodiments may provide techniques for focusing attention to the highest value narrative opportunities and risks. A computer-implemented method can include receiving input data identifying one or more characteristics associated with a target domain. The computer-implemented method can also include processing a corpus of unstructured data using the input data to generate a set of priority narratives associated with the target domain. The computer-implemented method can include determining, for each of the set of priority narratives, one or more propagation paths of the priority narrative across a digital communication network.

In an embodiment, a system comprises one or more processors and memory including instructions that, as a result of being executed by the one or more processors, cause the system to perform the processes described herein. In another embodiment, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

Illustrative embodiments are described in detail below with reference to the following figures.

FIG. 1 shows an example schematic diagram for performing focus-of-attention operation for generated narratives, according to some embodiments.

FIG. 2 illustrates an example presentation layer for viewing and exploring prioritized narratives, according to some embodiments.

FIG. 3 illustrates an example schematic diagram for an overall computational framework for focusing attention to the highest value narrative opportunities and risks, according to some embodiments.

FIG. 4 illustrates an example schematic diagram that describes a process of scoring a narrative via Boolean composer logic, according to some embodiments.

FIG. 5 shows an illustrative example of a process 500 for performing focus-of-attention operation for generated narratives, according to some embodiments.

FIG. 6 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

A challenge of the modern-information ecosystem is the degree to which public perception and the resulting discourse can be deliberately shaped by the tradecraft of modern influence campaigns, including means such as bot networks, disinformation, deep fakes, and autonomous AI-driven propaganda. To be in position to make informed assessments, form grounded opinions, and promote ideas effectively, individuals and organizations need methods for rapidly understanding what is being communicated that is of most relevance to them, both threats as well as opportunities, from large, diverse, and rapidly evolving digital datasets.

To address this challenge, the present techniques provide automatically surfacing the highest-value narratives. The resulting “focus-of-attention” operation can result in a reduction of many orders of magnitude in the number of documents that need to be reviewed. In addition, the identification of highest value narratives can automatically direct the users to adjust to the content that are highest value for their interests, including narratives that are at an emergent stage and very early in their evolution (low signal to noise in the data).

After the narratives of interest have been identified and prioritized, the present techniques automatically deconstruct them down to their mechanisms of propagation across user community networks. The deconstruction can include identification of key influential authors and the audiences engaged with them, and evidence of manipulation and tampering such as botlike accounts and coordinated synthetic amplification, including mis/disinformation, and deep fakes. A benefit provided includes allowing users to understand how these factors are interconnected, specifically the relationships between the authors, the content, and the audience, and the ability to distinguish authentic digital conversation from manufactured discourse.

The present techniques are thus directed to discovery of high value narratives and subsequent analysis to deconstruct their underlying mechanisms as “narrative intelligence”. The narrative intelligence described here provides users of the system with high fidelity situational understanding that is sufficiently actionable to inform whether and how they can respond to mitigate conversational threats. For example, if attacks on a brand driving a boycott are detected, a priority-narrative system can counteract by amplifying positive storylines about a company's new product line.

The present techniques provide significant sources of value and benefits. First, the priority-narrative system can be optimized to many domains and use cases while still leveraging a single analytics backend engine. For example, the degree of configurability enables one instance of the priority-narrative system to address a breadth of use cases including, but not limited to: enterprise brand risk, marketing opportunity identification, cyber-threat intelligence, foreign malign influence, platform trust and safety, and executive/celebrity protection. Second, the system engineering architecture provides favorable cost structure, graceful scalability to new problem domains, and efficiency in management of design complexity and maintenance overhead. The priority-narrative system also readily admits updates with enhanced machine-learning models and/or new classes of models to support an agile architecture which is a requirement for keeping pace with the rapidly evolving digital landscape. Finally, the present techniques directly save processing cost because we are able to narrow down the document set with cost-effective heuristics, and then deploy higher more expensive intelligence against what remains.

### I. Techniques for Focusing Attention to Priority Narratives

Organizations in both the public and private sectors have long been interested in taking advantage of information that is in the open public media space as a source of intelligence because of its immediate availability, relatively low cost (compared to specialized data collections) and population based perspectives. However, a challenge has been that the source is very “noisy” because it is filled with disparate and often irrelevant chatter, and it is also easily gamed by actors that are acting to influence perception through increasingly sophisticated manipulation tactics. So an approach to “denoise” Publicly Available Information (PAI) to a suitable level to use it for intelligence and high fidelity situational understanding was a requirement that led to the present techniques.

Another challenge to exploiting PAI is in the large volume and mix of document types which make timely manual review difficult and costly. So an efficient focus-of-attention operator is a critical need for this system. The present techniques can deliver users rapid and clear situational understanding with very high fidelity, and in a way that manipulation could be identified and separated from natural organic (non-gamed) chatter.

The ability to efficiently process large volumes of data with speed and at scale, while also providing exquisite fidelity analytic products is an intrinsically difficult technical challenge because the objectives of high fidelity analysis are often in direct tension with scalable processing. Brute force approaches that scale infrastructure to “boil the ocean” cannot compete in terms of latency or cost effectiveness with highly directed precision analytic approaches. The present techniques thus provide an architecture for narrative intelligence that provides high precision at scale, with low complexity and intuitive analyst constructs.

### A. Example Implementation

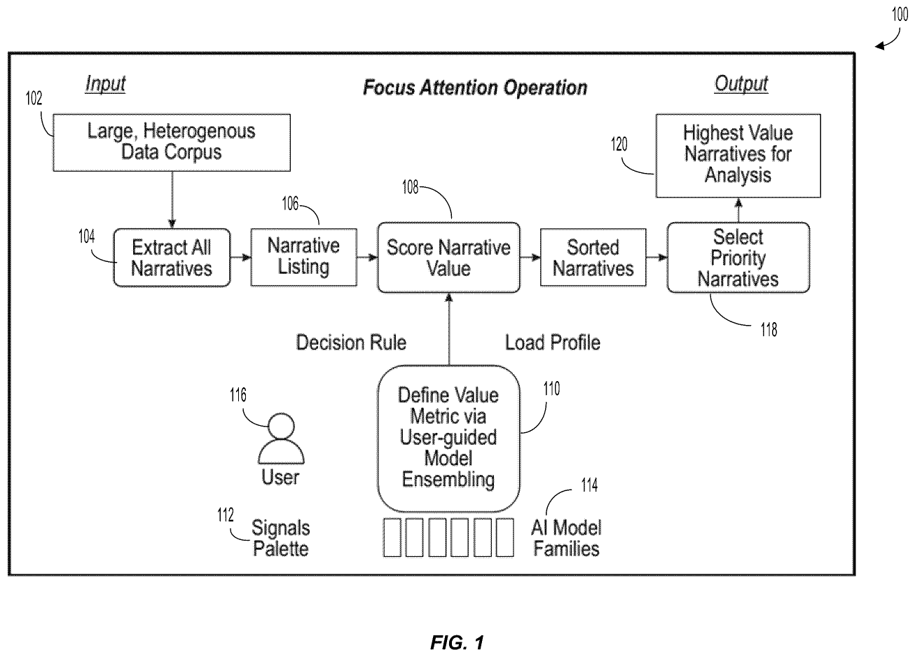

FIG. 1 shows an example schematic diagram 100 for performing focus-of-attention operation for generated narratives, according to some embodiments. At block 102, a priority-narrative system receives a data corpus, in which the narrative discovery is performed with a corpus of data including, but are not limited to:
Multimodal content: text, images, video, audio, and hypertext
Multiplatform: may originate from news and social media, deep and dark web sources, blogs, chat forums
Multilingual expression: adaptable to any language
Metadata: depending on the source, metadata such as author, timestamp, parent document (for a response), etc. is available for exploitation

In some embodiments, the data corpus may be ingested into the priority-narrative system as either a batch file or continuous real-time stream. The narratives can be extracted from this heterogeneous data by the priority-narrative system via aggregation across all these attributes concurrently. The initial collection of the document corpus at the top end of the processing funnel is typically directed toward broad topical areas or actor groups to gate the downstream analysis. To avoid missing relevant content, the gating mechanism can be kept as wide and open as practical for the scenario at hand.

At block 104, the priority-narrative system processes the data corpus to identify a set of narratives 106. As used herein, a narrative can refer to a conversational storyline that is centered on an extracted set of assertions or themes, such as claims that are expressed with a common stance on an issue. The narrative can be used to semantically match document content across the heterogeneous data corpus. In some instances, the narrative 106 can identify document authors and origination timestamps. For computational purposes, the narrative 106 may be represented as follows: (i) a cluster of clusters of documents that create a “flow” as the timeline evolves; (ii) a logical collection rule consistent with such aggregation that may be formed by a Boolean operator; (iii) a set of instructions for how to retrieve the narrative from (possibly unseen) document sets. In some instances, the set of instructions includes but are not limited to metadata filters, context-informed natural language description, key search phrases, or a workflow (e.g., a set of steps, possibly even a compiled executable) for retrieving matching content from the data corpus. In some instances, the narrative 106 may include claims which are extracted from all modalities of content. Example implementations of identifying the narratives are further described in U.S. Patent Application Nos. 63/779,454 and 63/748,577, the contents of which are herein incorporated by reference in its entirety for all purposes.

At block 108, the priority-narrative system can assign values to the narratives 106, such scoring the narrative as a risk or an opportunity. The value-assignment mechanism can be used to implement the focus-of-attention operation of the priority-narrative system in prioritizing and ranking narratives. For example, the value-assignment mechanism depends on a combination of signal factors to provide the meaningful insights for assessing narrative value.

In some instances, the priority-narrative system can determine narrative values using a signals framework 110 that includes: (i) a signal set selected from a signal palette 112; and (ii) machine-learning model ensembles 114 selected for fusing signals that derive composite scores. The signals framework 110 can include a set of independent and complementary attributes that provide a user 116 the palette 112 of narrative properties to select from. The selected signals can be configured for processing by the priority-narrative system, and can include factors for identifying narrative momentum, participating communities, and manipulation. In some instances, the signals are generated using a machine-learning model. For example, the signals include but are not limited to the following:
narrative content and tonality
   toxicity, emotion, sentiment, aspect-based sentiment, topics, calls to action, content units such as domains/images/hashtags and features of them
propagation dynamics
   trending, velocity, volume, depth, width, change over time period
network properties
   author-author connections; any combination of authors, channels, narratives or concepts; polarized graph structure, communities, density
actor behavioral profiles
   cohort affiliation, influence, engagement, Tactics Techniques and Procedures (TTPs)
manipulation factors
   botlike accounts, anomalous coordinated synthetic amplification, disinformation detections, digitally manipulated images and videos, AI generated deep fakes
geography
   country, region, state, city
narrative impact
   audience exposure, active audience size

Additionally or alternatively, the cohort models can be used to bring specificity to the surfacing of valuable narratives for specific client use cases, because they label the affiliations or factional memberships of online authors and audience members, including profiles such as organizational memberships (environmental activist), stances on social issues (anti-vaxx), political orientation, etc. In some instances, the signal palette 112 can be continually updated to keep pace with the dynamics of online communications. Attributes from the signals framework 110 can thus be selected by the user and combined to form composite risk or opportunity value profiles. The signals framework 110 facilitates the priority-narrative system to be directed to different use cases, and the performance of focus-of-attention can be optimized.

For generating the machine-learning model ensembles 114, an ensemble-formation operation can be implemented to be intuitive for subject matter experts. As an illustrative example, the user 116 can select machine-learning models to include in the composite value profile from a menu of options. The selected machine-learning models are configured to run as detectors (e.g., binary) that the user 116 can then combine using boolean constructors that include AND, OR, and NOT operators. In some instances, the ensemble-formation operation can be both dynamically configurable, with a high degree of specificity enabled, but it is also intuitive with minimal learning curve. Moreover, the ensemble-formation operation is readily adaptable to adjust logic as well as incorporate new signals without having to relearn a model, thereby enabling rapid insertion of new models and accelerated deployment. In some instances, the ensemble-formation operation provides readily accessible transparency and traceability as to what documents/authors were included in the value set.

The ensemble-formation operation results in a bucketing operation for collecting documents and authors, from which scoring is derived as a percentage contribution to the overall narrative. In some instances, the ensemble-formation operation may operate in a human-in-the-loop mode, with the users designing value profiles and trying them interactively with the selected machine-learning models. For example, once a profile has been established, the profile can be loaded and saved to a store of profiles, in which the profile can be pre-configured to run in fully automated mode and shared with collaborators across an organization. The profile can serve as a computational mechanism for an alert function, in which some narratives with scores exceeding a threshold value trigger one or more alerts.

The ensemble-formation operation (and the use of decision rules and Boolean constructors) can be further advantageous in the computer technology, as the approach can gracefully handle the insertion of new machine-learning models (thereby keeping the computer systems efficient in processing large volumes of data), including highly specific models requested by clients, while keeping the overall operational framework consistent. The ensemble-formation operation can be configured to enable rapid model insertion and accelerated deployment, leading to significant improvement in the computer technology. The approach also provides transparency and traceability, since it is straightforward to derive why a document/author was assigned a value label.

As an illustrative example, various combinations of machine-learning models can be dynamically ensembled using a decision rule to produce the composite value calculus to score narratives, including the following ensemble rule:

Risk/Threat scoring:
Foreign Information Manipulation & Interference (FIMI): Authoritarian State Supporter Accounts AND (Botlike Accounts OR Anomalous Amplification)
Brand Risk: Calls for Boycott AND Toxic Language OR Anger OR Disgust
Physical Risk: Calls for Protest AND Calls to Violence
Executive/Celebrity Reputational Risk: Calls for Smear Campaign AND (Disgust OR Disinformation)
   Opportunity scoring:
Brand Momentum: Happiness AND Surprise AND Brand Mention
Regional Market: In_Brazil AND Happiness AND Brand Mention

Additionally or alternatively, the machine-learning model ensembles 114 can be further refined or calibrated based on signal sets selected by the user from the signal palette 112. The signals can include factors for the machine-learning ensembles 114 for identifying narrative momentum, participating online communities, and manipulation factors, all of which can be used for identifying risks and exploiting opportunities in the narrative space. These signals give us visibility into any manipulation tradecraft being employed.

Examples of the machine-learning model (including sub-models of the multimodal model) of the ensemble can include algorithms such as k-means clustering algorithms, fuzzy c-means (FCM) algorithms, expectation-maximization (EM) algorithms, hierarchical clustering algorithms, and density-based spatial clustering of applications with noise (DBSCAN) algorithms, in which the algorithms can be trained using unsupervised learning. Other examples of the machine-learning model can include, but are not limited to, genetic algorithms, backpropagation, reinforcement learning, decision trees, linear classification, artificial neural networks, anomaly detection, and such. In yet other examples, the machine-learning model may include regression analysis, dimensionality reduction, metalearning, reinforcement learning, deep learning, and other such algorithms and/or methods.

In some instances, the machine-learning model is a transformer model (e.g., a large-language model (LLM)) obtained from a models database. In some instances, the machine-learning model is trained using self-supervised learning based on a large corpus of text data, such that the machine-learning model can generate narratives. In addition to training the model, various prompts can be used for prompt engineering of the machine-learning model for generating the narratives. Examples of the machine-learning model can include, but are not limited to, BERT model, Claude LLM, Falcon 40B, Ernie, GPT-3, GPT-3.5, GPT 4, Lamda, and Llama.

Once the machine-learning model ensembles 114 determine the value-scored narratives, a presentation and user-investigation layer of the priority-narrative system process the value-scored narratives to be presented in a customizable interface that allows the user to further sort and explore the narratives in a configurable 2D matrix referred to as the “narrative-prioritization matrix”. For example, at block 118, the user 116 can select a set of priority narratives 120 from the narrative-prioritization matrix for further analysis of certain information campaigns and narrative attacks. In some instances, the narrative-prioritization matrix can associate a particular narrative in a multi-dimensional graph, such as a first dimension identifying a volume of documents corresponding to the particular narrative and a second dimension identifying a score assigned to the particular narrative. As an illustrative example, the particular narrative can be associated with a low volume but a high narrative score, which may imply that the particular narrative is a high risk narrative that is just being propagated across different communication platforms.

### B. Narrative Prioritization Matrix

As described herein, a narrative prioritization matrix is an interactive visualization that helps an analyst triage narrative objects extracted from a corpus and scored under a selected value profile. The narrative prioritization matrix facilitates selection or user-specified modifications to the priority narratives. In the matrix, the priority-narrative system represents each narrative as a plotted point and positions the point using user-selected scoring dimensions (for example, risk score, engagement, and/or narrative volume such as original posts). This arrangement allows the analyst to compare many narratives at once and quickly identify which narratives warrant follow-on review.

The narrative prioritization matrix can include configurable axis selectors, filters (e.g., platform, time range, dataset scope), and visual encodings such as point size and point color to convey additional narrative attributes. In some embodiments, selecting or hovering on a point opens a narrative detail card that displays a narrative headline and identifier along with computed metrics such as a count of original posts, a risk score, an engagement metric, and an anomalous amplification metric. Using these elements, the matrix can identify narratives that are outliers (e.g., high risk and high anomalous activity), narratives that are high impact (e.g., high engagement), and narratives that are emerging (e.g., lower volume but elevated risk or acceleration signals).

In an example use case, an analyst can configure the matrix to emphasize risk and engagement, and can use color to highlight anomalous amplification, thereby making high-priority narratives visually prominent. The analyst can then select a point located in a high-risk region of the matrix and review the associated narrative detail card to confirm why the narrative ranks highly (for example, a narrative with a comparatively high risk score and anomalous metric, alongside a non-trivial engagement value and original-post count). After selecting the narrative, the analyst can proceed to drill into supporting documents, review contributing signals, and initiate downstream actions such as generating an alert or requesting propagation-path analysis for the selected priority narrative.

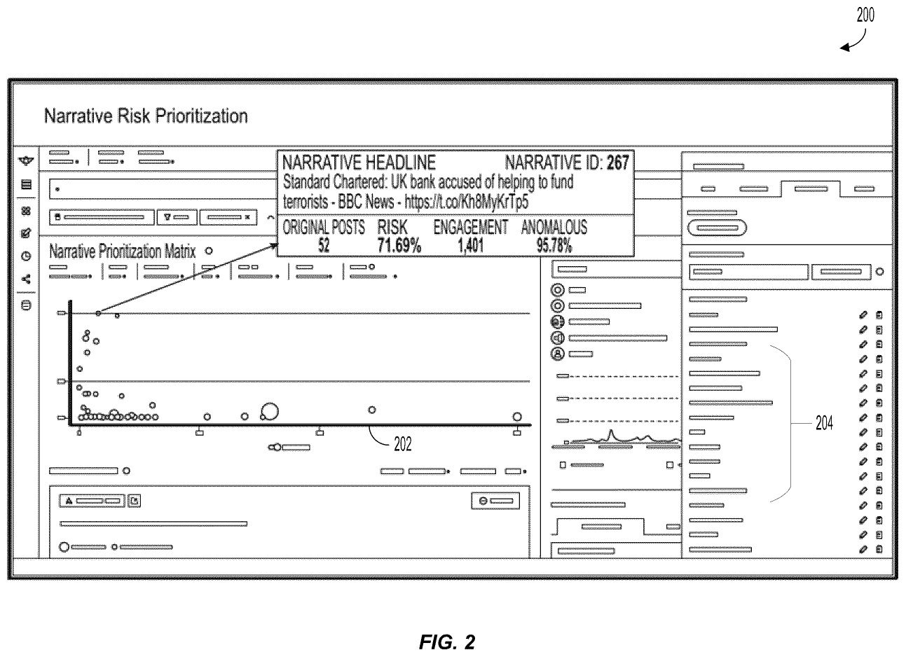

FIG. 2 illustrates an example presentation layer 200 for viewing and exploring prioritized narratives, according to some embodiments. The narrative prioritization matrix 202 presents narratives that have been scored and sorted by a risk value metric, as shown in this example for Brand Risk, that definition has been selected and applied from the store of preconfigured profiles 204 available. The use of the narrative prioritization matrix can initiate an in-depth narrative analysis and further breakdown into the details of the underlying signals such as network propagation and cohort localization. Additionally or alternatively, the highest value narratives may be surfaced and scored, then delivered directly into other systems via API.

The narrative prioritization matrix further enables addressing a wide variety of use cases via dynamic configuration to define “value” in terms of risk or opportunity, while leveraging common underlying signal sets. The flexibility enables rapid evolution of the priority-narrative system design and extension to new use cases without any re-engineering of the analytics pipeline. The above configurations also save processing cost because we are able to narrow down the document set with cost-effective heuristics, and then deploy higher more expensive intelligence against what remains.

The present techniques can be advantageous by keeping existing machine-learning models in the ensembles fresh, continuously introduce new models for new phenomena, and then deploy them rapidly into the platform with minimal impact to the rest of the system design. The present techniques can thus provide the agility to keep pace with constant evolution of data, in which the loci of conversations migrate platforms, the user communities constantly dissipate and reform, the topics of conversation and vernacular continually evolve. Even with the evolving data, the ensembling allows the computing systems to conserve computing resources when analyzing a large corpus of data while increasing performance efficiency and accuracy in detecting priority narratives.

The present techniques can also improve the computer technology by diagnosing narrative value and mechanisms of propagation at the signal level. The present techniques also allow the priority-narrative system to be highly adaptable to domain specific challenges and opportunities. The present techniques can thus take into consideration the authenticity of conversation and the mechanisms that actors wishing to influence public perception leverage, including bots, coordinated manipulation, disinformation, and deep fakes. This results in the consumers of the information to make well informed assessments about narrative threats and opportunities. Furthermore, the accurate diagnosis improves the computer systems to efficiently detect cybersecurity threats and perform rapid remedial operations (e.g., blacklisting, drop of network packets from suspicious IP addresses, tracking malicious users).

The present techniques can also be advantageous by providing the ability to surface “needles from the haystacks”, including emergent narratives that potentially present large threats or opportunities, but have not yet gone viral. This reduces the computing systems from being overwhelmed by the volume, velocity and variety of the public media data, which is not practical from a cost or latency perspective to build automated systems that process data in brute force fashion.

The present techniques can be deployed for numerous different use-cases. For example, The present techniques can be implemented in enterprise brand risk workflows to help organizations monitor and manage perception risk involving brand reputation, institutional trust, corporate valuation and stock price, supply chain exposure, and workforce-related issues. In some embodiments, the present techniques support strategic decision-making by surfacing narratives that influence stakeholder sentiment and market behavior, including narratives tied to broader contextual factors such as antitrust scrutiny, organized labor activity, and longer-horizon ESG initiatives.

The present techniques can be implemented in cyber and information security programs to provide threat intelligence for a portion of the attack surface that may be under-monitored: the external information environment. In some embodiments, the present techniques can surface early warning signals relating to threats against venues or executives, supply chain disruption narratives, hacking and cyber activism, and reputational impacts associated with breach-related narratives, whether the underlying incident is confirmed or unconfirmed. The present techniques can also be implemented to identify potential insider-risk indicators that have observable footprints in public sources, thereby supporting proactive posture adjustments by security teams.

The present techniques can be implemented in trust and safety operations to help protect user communities from harmful, manipulated, and/or coordinated information activity that may originate off-platform and then propagate onto a given platform. In some embodiments, the present techniques support platform integrity efforts by identifying how adversarial persuasion, manipulation, or amplification activity is occurring, characterizing propagation pathways and affected cohorts, and providing actionable signals that can be used to prioritize investigations and mitigation.

The present techniques can be implemented in national security and defense contexts to assess the broader information environment and to support deeper analysis of foreign malign influence and interference campaigns (FIMI). In some embodiments, the present techniques can be used to analyze Political-Military-Economic-Social-Information-Infrastructure (PMESII) information-domain operations and their potential impacts on national stability. The present techniques can also be implemented to provide open-source intelligence (OSINT) teams with technical enablement to scale analysis to high-volume, high-velocity datasets while preserving traceability, repeatability, and operational efficiency.

### C. Generating Machine-Learning Ensembles for Identifying Priority Narratives

As described above, existing systems create composite risk profiles by training a higher-level fusion model—often a hierarchical model—using supervised learning to combine outputs from multiple signal models. Such approach can be brittle because it is statically trained for a particular set of signal models and versions, and updates to those signal models or insertion of new models can require retraining the fusion model. It can also degrade in performance when the fusion method relies on statistical assumptions about relationships among the signal models (for example, independence) and those assumptions do not hold, which can force careful curation of the signal set. In addition, depending on the fusion model class, the resulting system can operate as a black box, making it difficult to understand how outputs are produced, how data was labeled, or how to diagnose performance issues. For these reasons, existing systems cannot practically leverage the richness of the signal sets described in the present disclosure while also providing aggregation mechanisms that are immediately tailorable to a given application domain.

To address the aforementioned deficiencies, the present techniques for defining and scoring composite value to narratives is based on a “loose coupling” approach to the model ensembling that trades higher performance on statically-defined point problems, with an easy to adapt, robust, interpretable, and flexible fusion method that is user directed and easy to understand. The present techniques can implement the loose coupling approach to process the signal sets for defining narrative risk and opportunity, and the methodology for combining those signals to create a composite measure of value. The loose coupling techniques enable accelerated development and system deployment, which can be advantageous in the computer technology as the applications and model sets are continuously evolving. The present techniques also provide a highly cost effective sieving approach where lower cost heuristics on the front end of the processing funnel provide significant reduction in the original document set to focus attention on the highest-value, priority narratives for more computationally sophisticated and expensive understanding operations.

Relative to the existing techniques described above, the present techniques provide several benefits. The present techniques support dynamically configurable fusion that is robust. Signal models can be updated, and new models can be integrated, without relearning a fusion model. Improvements to individual models can also propagate through to the overall fusion without retraining, which facilitates rapid model insertion and deployment. The present techniques can also operate with minimal statistical modeling assumptions because the signal models primarily rely on generally complementary attributes rather than strict distributional relationships. In addition, the present techniques provide clear-box performance because the combiner rule expresses decision logic in a form that is straightforward to validate, making it easier to understand why specific value assignments were produced. The present techniques are also intuitive and reusable because, once a fusion scheme is designed, it can be stored and shared with coworkers for consistent application across users and workflows.

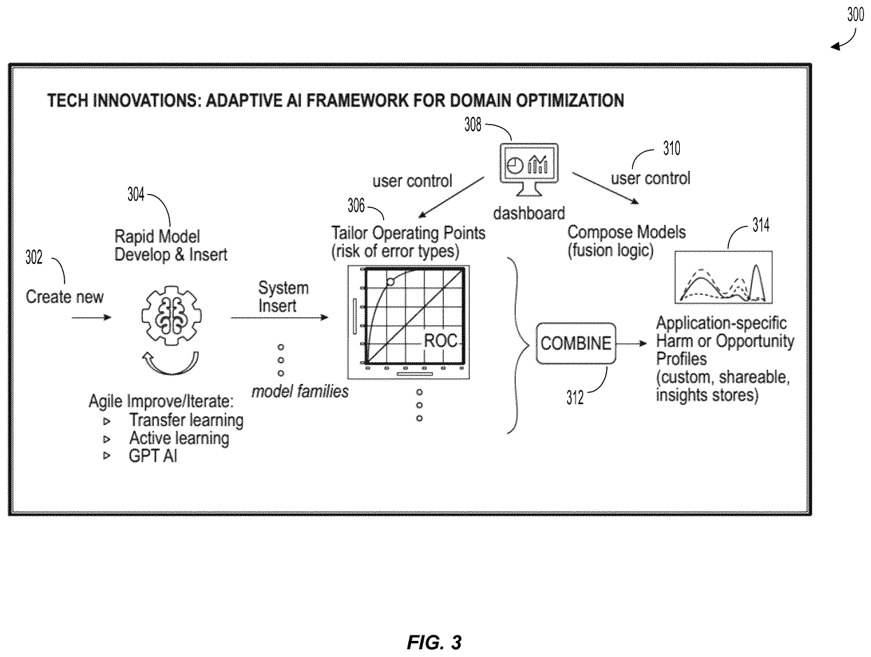

FIG. 3 illustrates an example schematic diagram 300 of a computational framework for focusing attention to higher-value narrative opportunities and risks, according to some embodiments. In this framework, a user-controlled composer or ensembling function enables dynamic creation of value profiles. In some embodiments, the narrative intelligence domain changes over time, and models can drift as online conversation, tactics, and content patterns evolve, including in political and social contexts. Accordingly, the present techniques can support rapid development, insertion, and updating of models within the system. The present techniques can also provide user-adjustable operating points that allow a user to tune error tradeoffs, such as balancing false positives versus misses for different detectors. In some embodiments, the user-adaptable composer function supports creation of model composites that can be tailored to a target domain and a selected risk or opportunity profile. In some commercial implementations, models, composer value profiles, and alert stores (e.g., preconfigured alerting rules) may be offered as selectable or configurable system components.

As shown in FIG. 3, the present techniques implements various mechanisms for computing a composite measure using a base implementation for model ensembling. At block 302, the priority-narrative system can create a new detector or application-specific objective when an operator initiates a “create new” action in an administrative console. The priority-narrative system can generate a model specification record (e.g., a ModelSpec) that defines a detector name, target labels, an input schema (document-level, author-level, or narrative-level), permitted modalities (text, image, video, or combinations thereof), and data-selection rules used to source training examples. The priority-narrative system can persist the ModelSpec in a model registry and can create a profile template that references the detector by identifier, thereby enabling downstream components to discover the detector even when a training job remains in progress (e.g., by marking the detector as pending with default configuration values).

At block 304, the priority-narrative system can rapidly develop and insert the detector by executing a training pipeline that reads the ModelSpec, assembles training data, and produces an initial model using transfer learning (e.g., fine-tuning a pretrained encoder for classification). The priority-narrative system can implement active learning by running the current model on unlabeled items, selecting samples based on uncertainty or model disagreement, and routing the selected samples to a labeling queue for human review. Where permitted, the priority-narrative system can also use an LLM-assisted labeling helper to propose draft labels and rationales, while retaining a reviewer confirmation step before adding examples to a training set. After training, the priority-narrative system can compute evaluation metrics, package the model as a deployable artifact (e.g., a container image or serialized model file), register a new version in the model registry, and insert the detector into production by deploying an inference service behind a stable endpoint. The priority-narrative system can group related detectors into model families by tagging each ModelSpec (e.g., toxicity, coordination, bot-likeness), which enables browsing and selection of detectors by category.

At block 306, the priority-narrative system can tailor detector operating points by generating calibration and tradeoff curves from validation results, including ROC and precision-recall curves. The priority-narrative system can store these curves as a versioned calibration object (e.g., a DetectorCalibration) that contains arrays of thresholds and associated metrics (TPR, FPR, precision, recall). When a user selects a threshold, the priority-narrative system can persist the threshold within a value profile as an operating-point parameter (e.g., threshold=0.82, min_confidence=0.65). During scoring, the priority-narrative system can apply the stored threshold to detector probabilities to generate predicates (true/false) that the composer logic can evaluate consistently across re-scores.

At block 308, the priority-narrative system can provide a dashboard control plane that exposes APIs to list detectors, fetch calibration artifacts, and write profile updates. The priority-narrative system can render interactive controls (e.g., sliders, curve plots, toggles) backed by versioned profile records, such that each change creates a new profile revision rather than overwriting prior settings. The priority-narrative system can validate updates by confirming detector availability, checking threshold ranges, and verifying model version compatibility, and the priority-narrative system can record audit events capturing the update, the actor, and the resulting profile version.

At block 310, the priority-narrative system can compose models by allowing a user to define fusion logic that combines detector predicates, such as (DetectorA AND DetectorB) OR NOT DetectorC. The priority-narrative system can serialize the fusion logic into a structured representation (e.g., an expression tree or abstract syntax tree) and can validate the representation by type-checking predicates, confirming referenced detectors are enabled, and confirming required inputs exist. The priority-narrative system can compile the validated representation into an executable form (e.g., postfix notation or compact bytecode) that a scoring service can evaluate efficiently, and the priority-narrative system can store the resulting fusion logic in a ValueProfile alongside detector selections and operating points.

At block 312, the priority-narrative system can combine detector outputs at runtime by executing a scoring service that reads narrative objects, retrieves detector outputs from a detector-output store, and evaluates the compiled composer expression to determine which documents, authors, and/or narratives satisfy the fusion logic. The priority-narrative system can compute composite values by aggregating evidence, such as a fraction of documents satisfying the rule, a reach-weighted share, an influence-weighted share, and an optional time-decayed contribution. The priority-narrative system can generate a composite score and an explanation object that identifies satisfied predicates and representative evidence items, thereby enabling traceability without rerunning detectors.

At block 314, the priority-narrative system can persist application-specific harm or opportunity profiles by storing each ValueProfile as a shareable configuration with access controls and version history. The priority-narrative system can link stored profiles to downstream insights stores such as ranked feeds, alerts, or case-management exports. When new narrative objects arrive, the priority-narrative system can score them under one or more stored profiles and write results into a results index keyed by profile identifier, thereby enabling fast retrieval of profile-specific outputs without recomputing upstream narrative extraction.

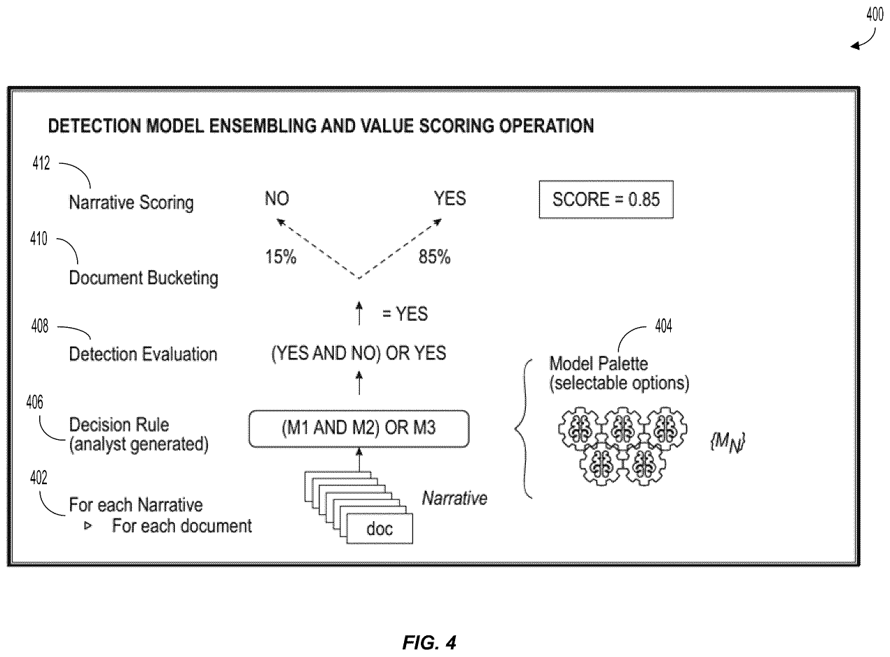

FIG. 4 illustrates an example schematic diagram 400 that describes a process of scoring a narrative via Boolean composer logic, according to some embodiments. In some embodiments, an analyst or subject matter expert selects models that are relevant to the value to be surfaced and specifies a logical structure describing how the selected models are combined, which may be referred to as a decision rule. The selected models are configured to run as detectors, and the user may adjust operating points to control the tradeoff between detections and false positives. The analyst can then combine detector predicates using a Boolean constructor that includes operators such as AND, OR, and NOT. The resulting rule can implement a bucketing operation that collects documents and authors satisfying the rule, and narrative scoring can be derived from those buckets as a percentage contribution to the overall narrative.

At block 402, the priority-narrative system can execute the scoring workflow by iterating “for each narrative” and then “for each document” in that narrative. The priority-narrative system can load a value profile for the scoring run and initialize per-narrative state, such as a total-document counter, YES/NO counters, and optional sets for distinct authors. The priority-narrative system can then stream documents through the remaining blocks so it can compute a narrative score after it evaluates all documents associated with the narrative.

At block 404, the priority-narrative system can provide a model palette that exposes selectable detector options (M1 . . . Mn) to an analyst and persists the analyst's selections. The priority-narrative system can store detector metadata (e.g., detector ID, model version, input schema, output type, and calibration artifacts) in a model registry and can link selected detectors to the value profile. The priority-narrative system can also persist per-detector operating points (e.g., thresholds or calibrated probability cutoffs) in the value profile so the priority-narrative system can convert detector outputs into consistent Boolean predicates during evaluation.

At block 406, the priority-narrative system can capture an analyst-generated decision rule that specifies how selected detectors are combined using Boolean logic, such as (M1 AND M2) OR M3. The priority-narrative system can represent the decision rule as a structured expression (e.g., an abstract syntax tree) to support validation and efficient execution. The priority-narrative system can validate the expression by confirming that referenced detectors exist in the selected palette and that each detector has an operating point configured, and the priority-narrative system can compile the validated expression into an executable form (e.g., postfix notation or a compact bytecode) and store it in the value profile.

At block 408, the priority-narrative system can perform detection evaluation for each document by generating detector predicates and applying the compiled Boolean decision rule. The priority-narrative system can retrieve detector outputs from a detector-output store (or call detector inference services when outputs are missing) and normalize outputs into comparable values (e.g., probabilities). The priority-narrative system can apply the stored operating points to convert each detector output into a YES/NO predicate and then evaluate the compiled rule to produce a single per-document outcome; for example, a document-level predicate set of (YES AND NO) OR YES can evaluate to YES under the rule (M1 AND M2) OR M3. The priority-narrative system can also store an explanation record that identifies which predicates contributed to the outcome and which detector versions and thresholds were applied.

At block 410, the priority-narrative system can implement document bucketing by assigning each evaluated document to a YES bucket or a NO bucket based on the rule outcome. The priority-narrative system can update per-narrative counters (e.g., increment YES or NO counts) and can optionally track distinct authors associated with each bucket to support author-level rollups. The priority-narrative system can also retain representative evidence for traceability, such as document IDs, author IDs, timestamps, and short excerpts or references, so downstream users can inspect why the narrative received its score.

At block 412, the priority-narrative system can compute the narrative score as a percentage contribution derived from the bucket results for the narrative. For example, after processing all documents in a narrative, the priority-narrative system can compute a score as YES_count divided by total_count (e.g., 0.85 when 85% of documents fall into the YES bucket and 15% fall into the NO bucket). The priority-narrative system can persist the narrative score, bucket statistics, and explanation artifacts in a narrative store and can use the score to rank narratives, trigger alerts, or drive a narrative prioritization interface.

In an alternative embodiment, the present techniques replace user-directed design of the fusion logic with a system that automatically learns the decision rule. In other alternative embodiments, an artificial-intelligence recommender assists the user by suggesting rule constructions based on user intent, or a natural language request is translated into a rule using a constrained mapping from phrases to detector predicates and operators. These approaches can accelerate creation of a value specification. In some embodiments, transparency is preserved so long as the fusion mechanism remains based on decision rules in an interpretable form.

### D. Methods

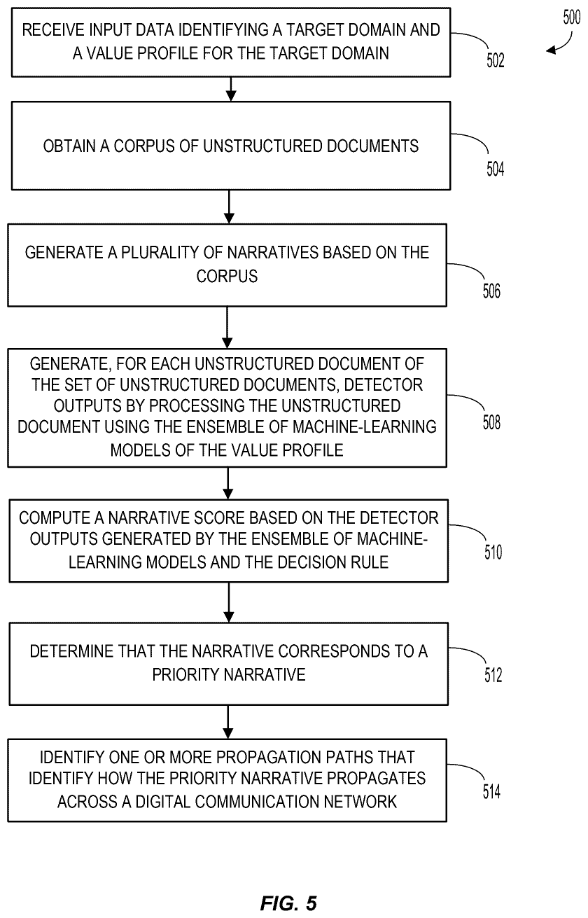

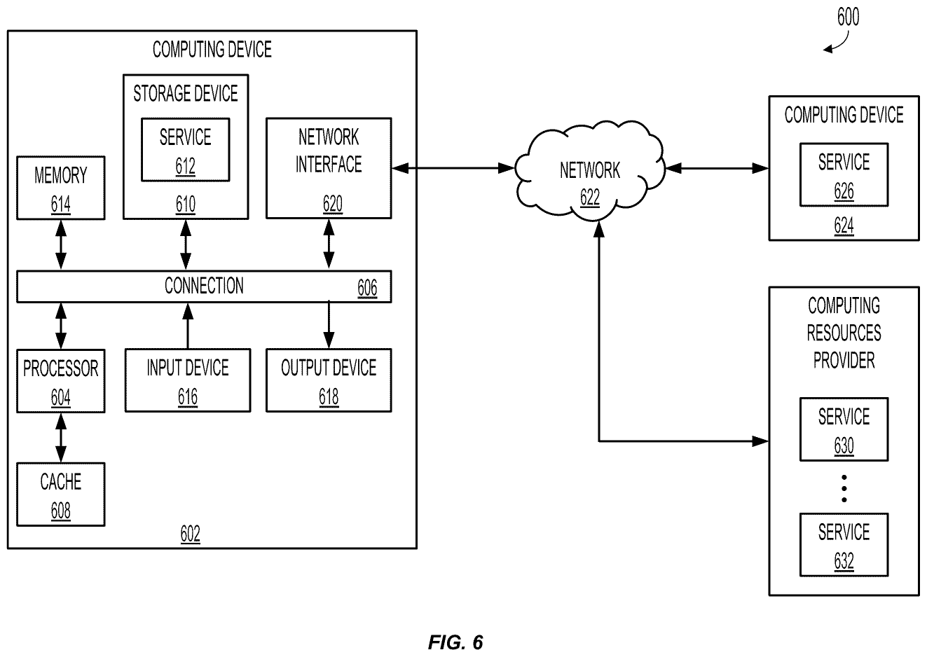

FIG. 5 shows an illustrative example of a process 500 for performing focus-of-attention operation for generated narratives, according to some embodiments. For illustrative purposes, the process 500 is described with reference to the components illustrated in FIGS. 1-4, though other implementations are possible. For example, the program code for the priority-narrative system of FIG. 1, is executed by one or more processing devices to cause a server system (e.g., the computing device 602 of FIG. 6) to perform one or more operations described herein.

At step 502, the priority-narrative system receives input data identifying a target domain and a value profile for the target domain. In some instances, the value profile includes: (i) an ensemble of machine-learning models; and (ii) a decision rule that specifies how a narrative score is calculated based on outputs generated by the ensemble of machine-learning models. In some instances, the ensemble of machine-learning models are selected from a model palette.

At step 504, the priority-narrative system obtains a corpus of unstructured documents. In some instances, each unstructured document includes multimodal content and corresponding metadata that identifies at least an author identifier and a timestamp.

At step 506, the priority-narrative system generates a plurality of narratives based on the corpus. In some instances, a narrative of the plurality of narratives identifies a set of unstructured documents that share one or more semantic characteristics.

At step 508, the priority-narrative system generates, for each unstructured document of the set of unstructured documents, detector outputs by processing the unstructured document using the ensemble of machine-learning models of the value profile.

At step 510, the priority-narrative system computes a narrative score based on the detector outputs generated by the ensemble of machine-learning models and the decision rule.

At step 512, the priority-narrative system determines that the narrative corresponds to a priority narrative. In some instances, the determination is based on the narrative score and the target domain.

At step 514, the priority-narrative system identifies one or more propagation paths that identify how the priority narrative propagates across a digital communication network. In some instances, the one or more propagation paths identify author identifiers that generated set of unstructured documents. In some instances, the priority-narrative system identifies the one or more propagation paths by: (i) constructing an interaction graph from the set of unstructured documents; and (ii) identifying a traversal path through the interaction graph that represents propagation of the priority narrative across authors of the set of unstructured documents. The priority-narrative system can also identify a disinformation-campaign operation or a narrative attack based on the one or more propagation paths. Additionally or alternatively, the priority-narrative system can identify identifying a positive sentiment associated with the priority narrative.

In some embodiments, the priority-narrative system generates a narrative prioritization matrix that identifies the priority narrative across a first dimension associated with volume of the set of unstructured documents and a second dimension associated with the narrative score.

### II. Example systems

FIG. 6 illustrates a computing system architecture 600, including various components in electrical communication with each other, in accordance with some embodiments. The example computing system architecture 600 illustrated in FIG. 6 includes a computing device 602, which has various components in electrical communication with each other using a connection 606, such as a bus, in accordance with some implementations. The example computing system architecture 600 includes a processing unit 604 that is in electrical communication with various system components, using the connection 606, and including the system memory 614. In some embodiments, the system memory 614 includes read-only memory (ROM), random-access memory (RAM), and other such memory technologies including, but not limited to, those described herein. In some embodiments, the example computing system architecture 600 includes a cache 608 of high-speed memory connected directly with, in close proximity to, or integrated as part of the processor 604. The system architecture 600 can copy data from the memory 614 and/or the storage device 610 to the cache 608 for quick access by the processor 604. In this way, the cache 608 can provide a performance boost that decreases or eliminates processor delays in the processor 604 due to waiting for data. Using modules, methods and services such as those described herein, the processor 604 can be configured to perform various actions. In some embodiments, the cache 608 may include multiple types of cache including, for example, level one (L1) and level two (L2) cache. The memory 614 may be referred to herein as system memory or computer system memory. The memory 614 may include, at various times, elements of an operating system, one or more applications, data associated with the operating system or the one or more applications, or other such data associated with the computing device 602.

Other system memory 614 can be available for use as well. The memory 614 can include multiple different types of memory with different performance characteristics. The processor 604 can include any general purpose processor and one or more hardware or software services, such as service 612 stored in storage device 610, configured to control the processor 604 as well as a special-purpose processor where software instructions are incorporated into the actual processor design. The processor 604 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 604 can be a microprocessor, a microcontroller, a digital signal processor (“DSP”), or a combination of these and/or other types of processors. In some embodiments, the processor 604 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 600, an input device 616 can represent any number of input mechanisms, such as a microphone for speech, a touch-sensitive screen for gesture or graphical input, keyboard, mouse, motion input, pen, and other such input devices. An output device 618 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 600. In some embodiments, the input device 616 and/or the output device 618 can be coupled to the computing device 602 using a remote connection device such as, for example, a communication interface such as the network interface 620 described herein. In such embodiments, the communication interface can govern and manage the input and output received from the attached input device 616 and/or output device 618. As may be contemplated, there is no restriction on operating on any particular hardware arrangement and accordingly the basic features here may easily be substituted for other hardware, software, or firmware arrangements as they are developed.

In some embodiments, the storage device 610 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described above, the storage device 610 can include hardware and/or software services such as service 612 that can control or configure the processor 604 to perform one or more functions including, but not limited to, the methods, processes, functions, systems, and services described herein in various embodiments. In some embodiments, the hardware or software services can be implemented as modules. As illustrated in example computing system architecture 600, the storage device 610 can be connected to other parts of the computing device 602 using the system connection 606. In some embodiments, a hardware service or hardware module such as service 612, that performs a function can include a software component stored in a non-transitory computer-readable medium that, in connection with the necessary hardware components, such as the processor 604, connection 606, cache 608, storage device 610, memory 614, input device 616, output device 618, and so forth, can carry out the functions such as those described herein.

The disclosed systems and service of a computational framework for focusing attention to the highest value narrative opportunities and risks can be performed using a computing system such as the example computing system illustrated in FIG. 6, using one or more components of the example computing system architecture 600. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and systems for focusing attention to the highest value narrative opportunities and risks (e.g., the framework described herein at least in connection with FIGS. 1-4) described herein by, for example, executing code using a processor such as processor 604 wherein the code is stored in memory such as memory 614 as described herein. One or more of a user device, a provider server or system, a database system, or other such devices, services, or systems may include some or all of the components of the computing system such as the example computing system illustrated in FIG. 6, using one or more components of the example computing system architecture 600 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 628. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 604 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 614 can be coupled to the processor 604 by, for example, a connector such as connector 606, or a bus. As used herein, a connector or bus such as connector 606 is a communications system that transfers data between components within the computing device 602 and may, in some embodiments, be used to transfer data between computing devices. The connector 606 can be a data bus, a memory bus, a system bus, or other such data transfer mechanism. Examples of such connectors include, but are not limited to, an industry standard architecture (ISA″ bus, an extended ISA (EISA) bus, a parallel AT attachment (PATA″ bus (e.g., an integrated drive electronics (IDE) or an extended IDE (EIDE) bus), or the various types of parallel component interconnect (PCI) buses (e.g., PCI, PCIe, PCI-104, etc.).

The memory 614 can include RAM including, but not limited to, dynamic RAM (DRAM), static RAM (SRAM), synchronous dynamic RAM (SDRAM), non-volatile random access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 614 can also include magnetic or optical data storage media including read-only (e.g., CD ROM and DVD ROM) or otherwise (e.g., CD or DVD). The memory can be local, remote, or distributed.

As described above, the connector 606 (or bus) can also couple the processor 604 to the storage device 610, which may include non-volatile memory or storage and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 610. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 606 can also couple the processor 604 to a network interface device such as the network interface 620. The interface can include one or more of a modem or other such network interfaces including, but not limited to those described herein. It will be appreciated that the network interface 620 may be considered to be part of the computing device 602 or may be separate from the computing device 602. The network interface 620 can include one or more of an analog modem, Integrated Services Digital Network (ISDN) modem, cable modem, token ring interface, satellite transmission interface, or other interfaces for coupling a computer system to other computer systems. In some embodiments, the network interface 620 can include one or more input and/or output (I/O) devices. The I/O devices can include, by way of example but not limitation, input devices such as input device 616 and/or output devices such as output device 618. For example, the network interface 620 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™, SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 602 can be connected to one or more additional computing devices such as computing device 624 via a network 622 using a connection such as the network interface 620. In such embodiments, the computing device 624 may execute one or more services 626 to perform one or more functions under the control of, or on behalf of, programs and/or services operating on computing device 602. In some embodiments, a computing device such as computing device 624 may include one or more of the types of components as described in connection with computing device 602 including, but not limited to, a processor such as processor 604, a connection such as connection 606, a cache such as cache 608, a storage device such as storage device 610, memory such as memory 614, an input device such as input device 616, and an output device such as output device 618. In such embodiments, the computing device 624 can carry out the functions such as those described herein in connection with computing device 602. In some embodiments, the computing device 602 can be connected to a plurality of computing devices such as computing device 624, each of which may also be connected to a plurality of computing devices such as computing device 624. Such an embodiment may be referred to herein as a distributed computing environment.

The network 622 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 622 can be wired connections, wireless connections, or combinations thereof. Communications via the network 622 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 622, within the computing device 602, within the computing device 624, or within the computing resources provider 628 can include information, which also may be referred to herein as content. The information may include text, graphics, audio, video, haptics, and/or any other information that can be provided to a user of the computing device such as the computing device 602. In some embodiments, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 602 and presented to a user of the computing device 602 using forms that are perceptible via sight, sound, smell, taste, touch, or other such mechanisms. In some embodiments, communications over the network 622 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 602 and/or the computing device 624 can be connected to a computing resources provider 628 via the network 622 using a network interface such as those described herein (e.g. network interface 620). In such embodiments, one or more systems (e.g., service 630 and service 632) hosted within the computing resources provider 628 (also referred to herein as within “a computing resources provider environment”) may execute one or more services to perform one or more functions under the control of, or on behalf of, programs and/or services operating on computing device 602 and/or computing device 624. Systems such as service 630 and service 632 may include one or more computing devices such as those described herein to execute computer code to perform the one or more functions under the control of, or on behalf of, programs and/or services operating on computing device 602 and/or computing device 624.

For example, the computing resources provider 628 may provide a service, operating on service 630 to store data for the computing device 602 when, for example, the amount of data that the computing device 602 exceeds the capacity of storage device 610. In another example, the computing resources provider 628 may provide a service to first instantiate a virtual machine (VM) on service 632, use that VM to access the data stored on service 632, perform one or more operations on that data, and provide a result of those one or more operations to the computing device 602. Such operations (e.g., data storage and VM instantiation) may be referred to herein as operating “in the cloud,” “within a cloud computing environment,” or “within a hosted virtual machine environment,” and the computing resources provider 628 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 628 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, server-less hosting, virtual reality (VR) systems, and augmented reality (AR) systems. Various techniques to facilitate such services include, but are not be limited to, virtual machines, virtual storage, database services, system schedulers (e.g., hypervisors), resource management systems, various types of short-term, mid-term, long-term, and archival storage devices, etc.

As may be contemplated, the systems such as service 630 and service 632 may implement versions of various services (e.g., the service 612 or the service 626) on behalf of, or under the control of, computing device 602 and/or computing device 624. Such implemented versions of various services may involve one or more virtualization techniques so that, for example, it may appear to a user of computing device 602 that the service 612 is executing on the computing device 602 when the service is executing on, for example, service 630. As may also be contemplated, the various services operating within the computing resources provider 628 environment may be distributed among various systems within the environment as well as partially distributed onto computing device 624 and/or computing device 602.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a key pad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 602) include, but is not limited to, desktop computers, laptop computers, server computers, hand-held computers, tablets, smart phones, personal digital assistants, digital home assistants, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purpose computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram. Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, linear classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital assistants (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 602.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 45 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that the same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method comprising:
receiving input data identifying a target domain and a value profile for the target domain, wherein the value profile includes: (i) an ensemble of machine-learning models; and (ii) a decision rule that specifies how a narrative score is calculated based on outputs generated by the ensemble of machine-learning models;
obtaining a corpus of unstructured documents, wherein each unstructured document includes multimodal content, and corresponding metadata that identifies at least an author identifier and a timestamp;
generating a plurality of narratives based on the corpus, wherein a narrative of the plurality of narratives identifies a set of unstructured documents that share one or more semantic characteristics;
generating, for each unstructured document of the set of unstructured documents, detector outputs by processing the unstructured document using the ensemble of machine-learning models of the value profile;
computing a narrative score based on the detector outputs generated by the ensemble of machine-learning models and the decision rule;
determining that the narrative corresponds to a priority narrative, wherein the determination is based on the narrative score and the target domain; and
identifying one or more propagation paths that identify how the priority narrative propagates across a digital communication network.

2. The computer-implemented method of claim 1, wherein the one or more propagation paths identify author identifiers that generated set of unstructured documents.

3. The computer-implemented method of claim 1, wherein identifying the one or more propagation paths includes:
constructing an interaction graph from the set of unstructured documents; and
identifying a traversal path through the interaction graph that represents propagation of the priority narrative across authors of the set of unstructured documents.

4. The computer-implemented method of claim 1, further comprising identifying a disinformation-campaign operation or a narrative attack based on the one or more propagation paths.

5. The computer-implemented method of claim 1, further comprising identifying a positive sentiment associated with the priority narrative.

6. The computer-implemented method of claim 1, wherein the ensemble of machine-learning models are selected from a model palette.

7. The computer-implemented method of claim 1, further comprising generating a narrative prioritization matrix that identifies the priority narrative across a first dimension associated with volume of the set of unstructured documents and a second dimension associated with the narrative score.

8. A system comprising:
one or more processors; and
memory storing thereon instructions that, as a result of being executed by the one or more processors, cause the system to perform operations comprising:
receiving input data identifying a target domain and a value profile for the target domain, wherein the value profile includes: (i) an ensemble of machine-learning models; and (ii) a decision rule that specifies how a narrative score is calculated based on outputs generated by the ensemble of machine-learning models;
obtaining a corpus of unstructured documents, wherein each unstructured document includes multimodal content, and corresponding metadata that identifies at least an author identifier and a timestamp;
generating a plurality of narratives based on the corpus, wherein a narrative of the plurality of narratives identifies a set of unstructured documents that share one or more semantic characteristics;
generating, for each unstructured document of the set of unstructured documents, detector outputs by processing the unstructured document using the ensemble of machine-learning models of the value profile;
computing a narrative score based on the detector outputs generated by the ensemble of machine-learning models and the decision rule;
determining that the narrative corresponds to a priority narrative, wherein the determination is based on the narrative score and the target domain; and
identifying one or more propagation paths that identify how the priority narrative propagates across a digital communication network.

9. The system of claim 8, wherein the one or more propagation paths identify author identifiers that generated set of unstructured documents.

10. The system of claim 8, wherein identifying the one or more propagation paths includes:
constructing an interaction graph from the set of unstructured documents; and
identifying a traversal path through the interaction graph that represents propagation of the priority narrative across authors of the set of unstructured documents.

11. The system of claim 8, wherein the instructions further cause the system to perform operations comprising identifying a disinformation-campaign operation or a narrative attack based on the one or more propagation paths.

12. The system of claim 8, wherein the instructions further cause the system to perform operations comprising identifying a positive sentiment associated with the priority narrative.

13. The system of claim 8, wherein the ensemble of machine-learning models are selected from a model palette.

14. The system of claim 8, wherein the instructions further cause the system to perform operations comprising generating a narrative prioritization matrix that identifies the priority narrative across a first dimension associated with volume of the set of unstructured documents and a second dimension associated with the narrative score.

15. A non-transitory, computer-readable storage medium storing thereon executable instructions that, as a result of being executed by one or more processors of a computer system, cause the computer system to perform operations comprising:
receiving input data identifying a target domain and a value profile for the target domain, wherein the value profile includes: (i) an ensemble of machine-learning models; and (ii) a decision rule that specifies how a narrative score is calculated based on outputs generated by the ensemble of machine-learning models;
obtaining a corpus of unstructured documents, wherein each unstructured document includes multimodal content, and corresponding metadata that identifies at least an author identifier and a timestamp;
generating a plurality of narratives based on the corpus, wherein a narrative of the plurality of narratives identifies a set of unstructured documents that share one or more semantic characteristics;
generating, for each unstructured document of the set of unstructured documents, detector outputs by processing the unstructured document using the ensemble of machine-learning models of the value profile;
computing a narrative score based on the detector outputs generated by the ensemble of machine-learning models and the decision rule;
determining that the narrative corresponds to a priority narrative, wherein the determination is based on the narrative score and the target domain; and
identifying one or more propagation paths that identify how the priority narrative propagates across a digital communication network.

16. The non-transitory, computer-readable storage medium of claim 15, wherein the one or more propagation paths identify author identifiers that generated set of unstructured documents.

17. The non-transitory, computer-readable storage medium of claim 15, wherein identifying the one or more propagation paths includes:
constructing an interaction graph from the set of unstructured documents; and
identifying a traversal path through the interaction graph that represents propagation of the priority narrative across authors of the set of unstructured documents.

18. The non-transitory, computer-readable storage medium of claim 15, wherein the instructions further cause the computer system to perform operations comprising identifying a disinformation-campaign operation or a narrative attack based on the one or more propagation paths.

19. The non-transitory, computer-readable storage medium of claim 15, wherein the instructions further cause the computer system to perform operations comprising identifying a positive sentiment associated with the priority narrative.

20. The non-transitory, computer-readable storage medium of claim 15, wherein the instructions further cause the computer system to perform operations comprising generating a narrative prioritization matrix that identifies the priority narrative across a first dimension associated with volume of the set of unstructured documents and a second dimension associated with the narrative score.
